(19) United States
(12) Patent Application Publication
(10) Pub. No.: US 2004/0261475 A1
(43) Pub. Date: Dec. 30, 2004

(54) Locking amplifier

(76) Inventor: Eyal Artsiely, Moshav Fazael (IL)

Correspondence Address: NIXON & VANDERHYE, PC, 1100 N GLEBE ROAD, 8TH FLOOR, ARLINGTON, VA, 22201-4714, US

(21) Appl. No.: 10/496,646

(22) PCT Filed: Nov. 26, 2002
(86) PCT No.: PCT/IL02/00951

(30) Foreign Application Priority Data
Nov. 26, 2001 (IL) 146740

(51) Int. Cl. E05B 59/00; E05B 63/14; E05B 47/00

(52) U.S. Cl. 70/107; 70/279.1

(57) ABSTRACT

A modular, enhanced action, lock assembly including a lock assembly providing axial bolt driving along at least one longitudinal axis and an enhanced action assembly, mounted onto the lock assembly for being driven at least partially by the axial bolt driving along the longitudinal axis for providing enhanced locking action.

### FIELD OF THE INVENTION

The present invention relates to Locks and more particularly to mortise locks.

### BACKGROUND OF THE INVENTION

Various types of mortise locks are known in the art. The following U.S. patents are believed to represent the current state of the art: 5,605,362; 5,620,216; 5,622,065; 5,628,216; 5,634,508; 5,640,863; 5,678,870; 5,697,653; 5,722,276; 5,730,478; 5,754,107; 5,765,410; 5,794,466; 5,813,255; 5,820,170; 5,820,173; 5,820,177; 5,826,451; 5,832,758; 5,878,605; 5,884,512; 5,884,515; 5,890,753; 5,921,191; 5,927,011; 5,927,019; 5,934,116; 5,947,534; 5,951,068; 5,953,942; 5,964,111; 5,970,759; 5,986,564; 5,992,195; 6,003,351; 6,036,239; 6,038,896; 6,042,161; 6,062,929; 6,131,966; 6,174,004; 6,209,931; 6,217,087; 6,250,119; 6,264,252; 6,266,981; 6,282,929; 6,286,186; 6,286,347; 6,301,852.

### SUMMARY OF THE INVENTION

The present invention seeks to provide an enhanced action lock.

There is thus provided in accordance with a preferred embodiment of the present invention a modular, enhanced action, lock assembly comprising:

a lock assembly providing axial bolt driving along at least one longitudinal axis; and

an enhanced action assembly, mounted onto the lock assembly for being driven at least partially by the axial bolt driving along the at least one longitudinal axis for providing enhanced locking action.

There is additionally provided in accordance with a preferred embodiment of the present invention, for use in a modular, enhanced action, lock assembly comprising a lock assembly providing axial bolt driving along at least one longitudinal axis,

an enhanced action assembly, mounted onto the lock assembly for being driven at least partially by the axial bolt driving along the at least one longitudinal axis for providing enhanced locking action.

Preferably, the lock assembly comprises a manually driven lock assembly.

In accordance with one embodiment of the present invention, the lock assembly comprises an at least partially electrically driven lock assembly.

Preferably, the enhanced action assembly provides, in response to the axial bolt driving, a multiple bolt locking action.

In accordance with a preferred embodiment of the present invention, the enhanced action assembly provides, in response to the axial bolt driving, a drop bolt locking action.

Additionally in accordance with a preferred embodiment of the present invention, the enhanced action assembly provides, in response to the axial bolt driving, a multiple direction locking action.

Further in accordance with a preferred embodiment of the present invention, the enhanced action assembly provides, in response to the axial bolt driving, an extended throw locking action.

Still further in accordance with a preferred embodiment of the present invention, the enhanced action assembly provides, in response to the axial bolt driving, an electrically monitored locking action.

Yet further in accordance with a preferred embodiment of the present invention, the enhanced action assembly provides, partially in response to the axial bolt driving, a partially electrically operated and partially mechanically operated locking action.

Also in accordance with a preferred embodiment of the present invention, the enhanced action assembly provides, partially in response to the axial bolt driving, a partially electrically operated and partially mechanically operated locking action wherein at least one of a latch and at least one of a bolt are differently operated.

### BRIEF DESCRIPTION OF TEE DRAWINGS

The present invention will be understood and appreciated more fully from the following detailed description, taken in conjunction with the drawings in which:

FIGS. 1A, 1B and 1C are simplified pictorial illustrations of an enhanced action lock assembly constructed and operative in accordance with a preferred embodiment of the present invention in three alternative operative orientations;

FIGS. 2A, 2B and 2C are simplified pictorial illustrations of various different types of latches useful in the embodiment of FIGS. 1A-1C;

FIGS. 3A, 3B and 3C are simplified pictorial illustrations of an enhanced action drop bolt lock assembly constructed and operative in accordance with a preferred embodiment of the present invention in three alternative operative orientations;

FIGS. 4A, 4B and 4C are simplified exploded view pictorial illustrations of an enhanced action multiple direction lock assembly constructed and operative in accordance with a preferred embodiment of the present invention in three alternative operative orientations;

FIGS. 5A, 5B and 5C are simplified pictorial illustrations of the enhanced action multiple direction lock assembly of FIGS. 4A, 4B and 4C respectively;

FIGS. 6A, 6B and 6C are simplified pictorial illustrations of an enhanced action extended throw lock assembly constructed and operative in accordance with a preferred embodiment of the present invention in three alternative operative orientations;

FIGS. 7A, 7B and 7C are simplified pictorial illustrations of an enhanced action electrically monitored lock assembly constructed and operative in accordance with a preferred embodiment of the present invention in three alternative operative orientations;

FIGS. 8A, 8B, 8C, 8D and 8E are simplified pictorial illustrations of one type of an enhanced action partially electrically operated and partially mechanically operated lock assembly constructed and operative in accordance with, a preferred embodiment of the present invention in five alternative operative orientations;

FIGS. 9A, 9B, 9C and 9D are simplified pictorial illustrations of another type of an enhanced action partially electrically operated and partially mechanically operated lock assembly constructed and operative in accordance with a preferred embodiment of the present invention in four alternative operative orientations; and

FIG. 10 is a simplified pictorial illustration of another type of enhanced action multiple direction lock assembly constructed and operative in accordance with a preferred embodiment of the present invention.

### DETAILED DESCRIPTION OF PREFERRED EMBODIMENTS

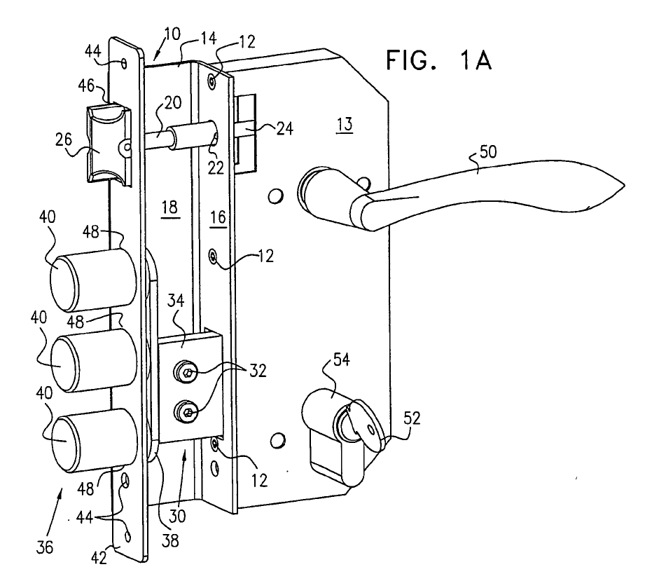

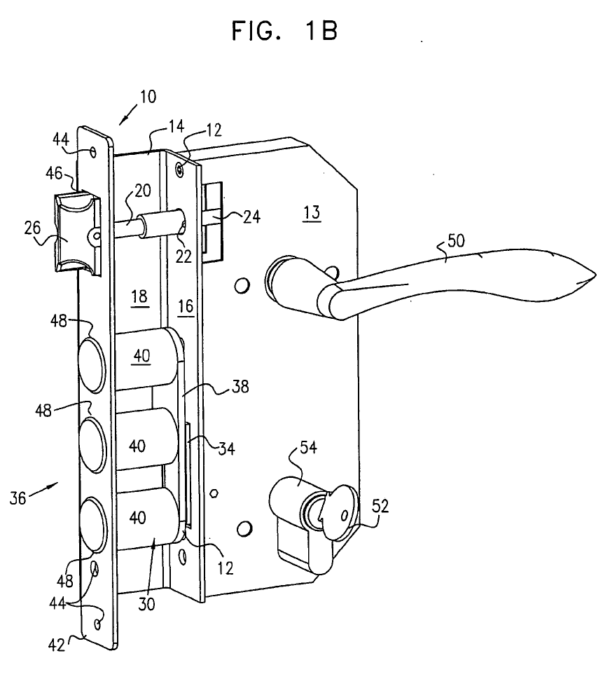

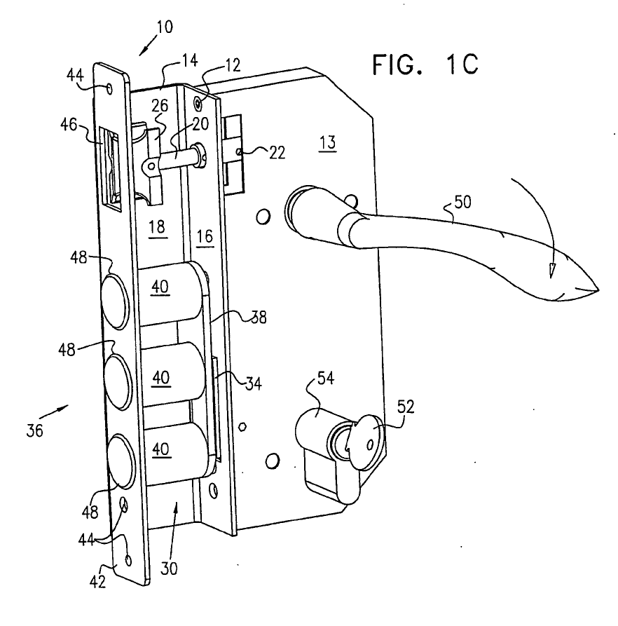

Reference is now made to FIGS. 1A, 1B and 1C, which are simplified pictorial illustrations of an enhanced action lock assembly constructed and operative in accordance with a preferred embodiment of the present invention in three alternative operative orientations. As seen in FIGS. 1A, 1B and 1C, an enhanced action assembly 10 is mounted, as by screw fasteners or rivets 12, onto an outer edge of a conventional lock, here a mortise lock 13.

The enhanced action assembly 10 preferably comprises an assembly support 14 including a mounting panel 16 which is mounted by screw fasteners or rivets 12 onto the outer edge of the mortise lock 13 and which is preferably integrally formed with a side panel 18, which extends outwardly from mounting panel 16 and is preferably integrally formed therewith A latch elongating assembly 20 is preferably mounted, as by a set screw 22, onto a latch shaft 24 of the mortise lock 13. A latch 26 is mounted to an outer facing end of assembly 20.

A bolt elongating shaft assembly 30 is preferably mounted, as by set screws 32, onto a bolt 34 of the mortise lock 13. A multiple bolt assembly 36 is mounted to an outer facing end of assembly 30. Multiple bolt assembly 36 preferably comprises a base 38 onto which are mounted a plurality of bolts 40. An edge plate 42 is provided for mounting on an edge of a door (not shown) and is suitably apertured with mounting screw mounting apertures 44, a latch aperture 46 and bolt apertures 48.

It is seen from a consideration of FIG. 1A, that both the latch 26 and the bolts 40 are fully extended when a lock handle 50 is in a generally horizontal position and when a key 52 in a cylinder 54 is in a first rotational orientation, here shown tilted to the left.

It is seen from a consideration of FIG. 1B, that when key 52 in cylinder 54 is in a second rotational orientation, here shown tilted to the right, bolts 40 are fully retracted.

It is seen from a consideration of FIG. 1C, that both the latch 26 and the bolts 40 are fully retracted when lock handle 50 is in a generally downwardly tilted position and when key 52 in cylinder 54 is in a second rotational orientation, here shown tilted to the right.

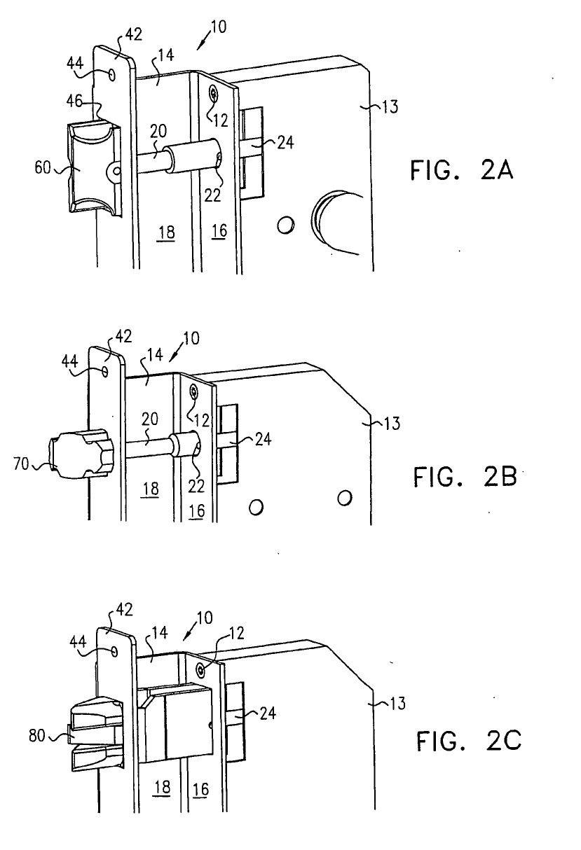

Reference is now made to FIGS. 2A, 2B and 2C, which are simplified pictorial illustrations of various different types of latches useful in the embodiment of FIGS. 1A-1C. FIG. 2A shows a generally trapezoidal latch 60, while FIG. 2B shows a multiply grooved latch 70. FIG. 2C shows a multi-element latch 80.

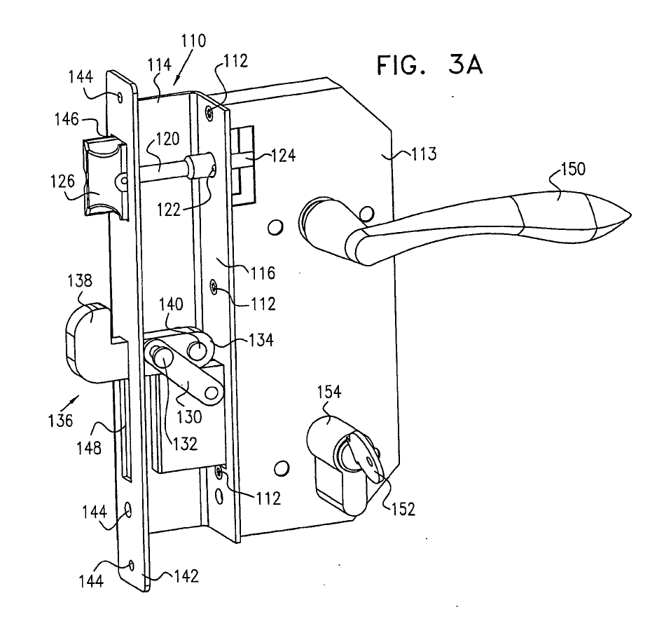

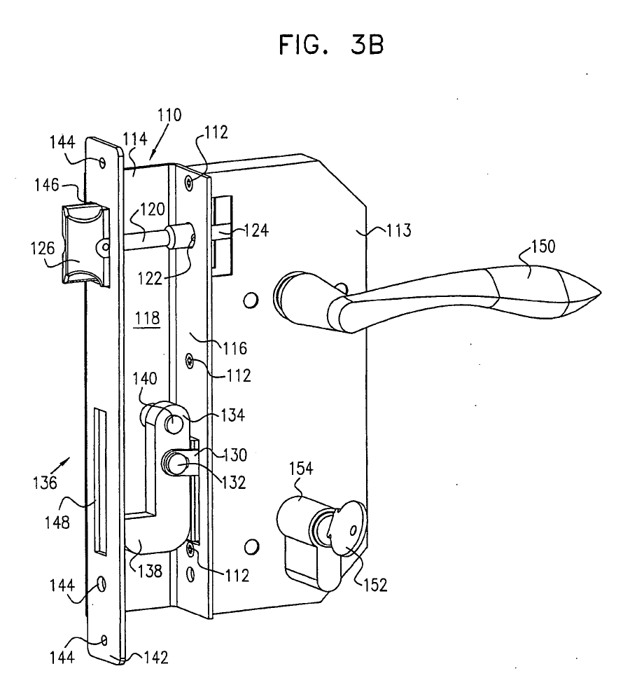

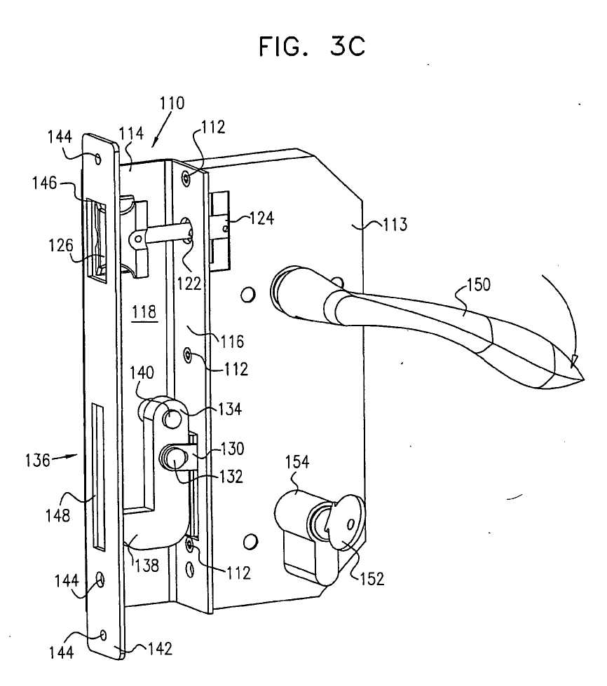

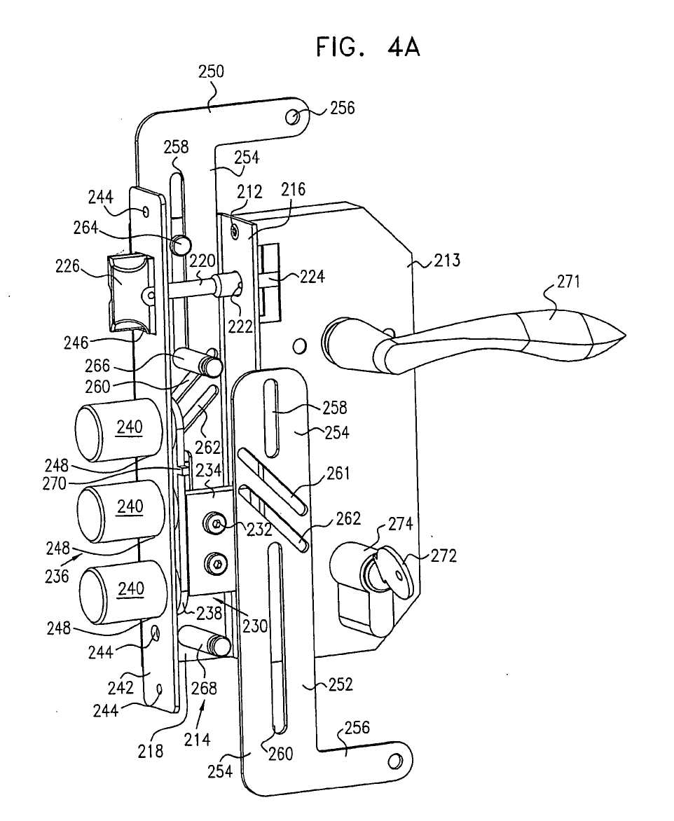

Reference is now made to FIGS. 3A, 3B and 3C, which are simplified pictorial illustrations of an enhanced action drop bolt lock assembly constructed and operative in accordance with a preferred embodiment of the present invention in three alternative operative orientations. As seen in FIGS. 3A, 3B and 3C, an enhanced action assembly 110 is mounted, as by screw fasteners 112, onto an outer edge of a conventional lock, here a mortise lock 113.

The enhanced action assembly 110 preferably comprises an assembly support 114 including a mounting panel 116 which is mounted by screw fasteners 112 onto the outer edge of the mortise lock 113 and which is preferably integrally formed with a side panel 118, which extends outwardly from mounting panel 116 and is preferably integrally formed therewith.

A latch elongating assembly 120 is preferably mounted, as by a set screw 122, onto a latch shaft 124 of the mortise lock 113. A latch 126 is mounted to an outer facing end of assembly 120.

A bolt-hook rotating arm 130 is preferably mounted, as by a pin 132, onto a bolt 134 of the mortise lock 113. A bolt hook assembly 136 is mounted to an outer facing end of arm 130. Bolt hook assembly 136 preferably comprises a bolt hook 138 which is pivotably mounted onto side panel 118 by means of a pin 140 and which is rotated about pin 140 by rotation of arm 130 upon extension of bolt 134. An edge plate 142 is provided for mounting on an edge of a door (not shown) and is suitably apertured with mounting screw mounting apertures 144, a latch aperture 146 and a bolt aperture 148.

It is seen from a consideration of FIG. 3A, that both the latch 126 and the bolt hook 138 are fully extended when a lock handle 150 is in a generally horizontal position and when a key 152 in a cylinder 154 is in a first rotational orientation, here shown tilted to the left.

It is seen from a consideration of FIG. 3B, that when key 152 in cylinder 154 is in a second rotational orientation, here shown tilted to the right, bolt book 138 is fully retracted.

It is seen from a consideration of FIG. 3C, that both the latch 126 and the bolt hook 138 are fully retracted when lock handle 150 is in a generally downwardly tilted position and when key 152 in cylinder 154 is in a second rotational orientation, here shown tilted to the right.

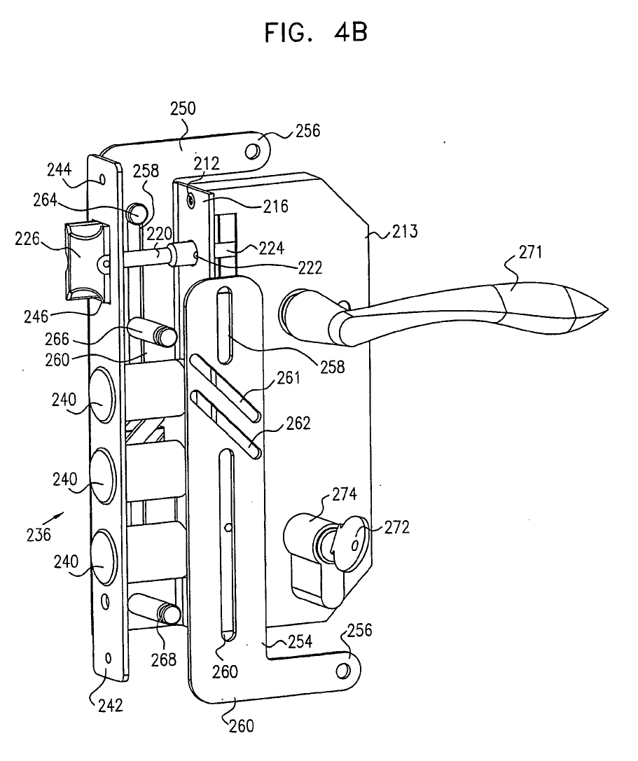

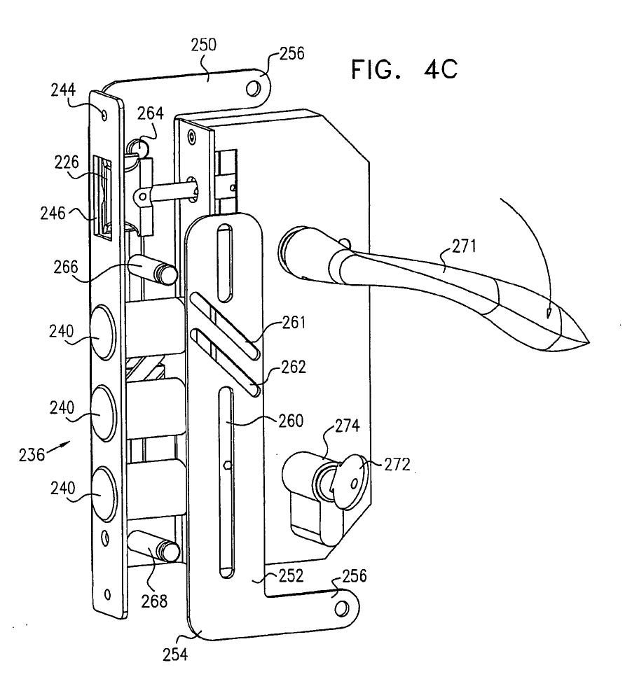

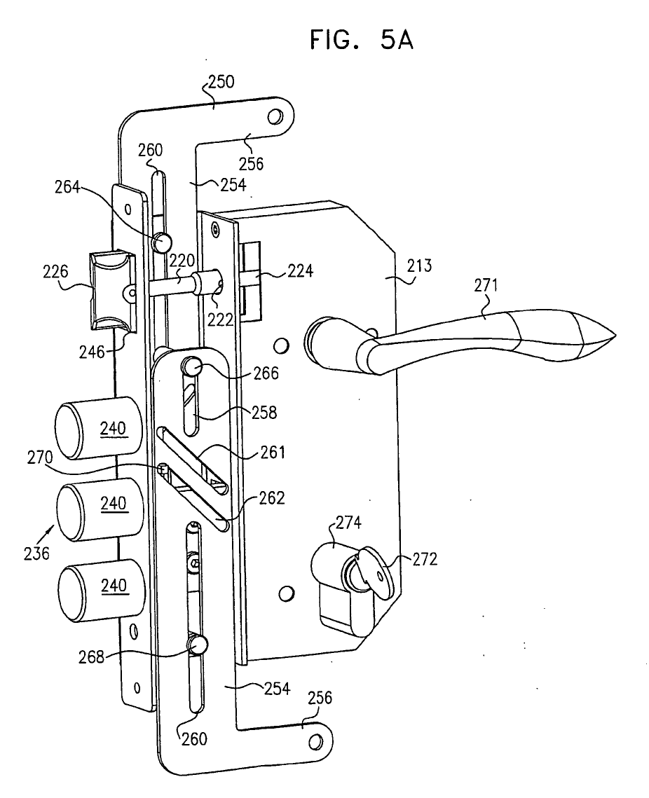

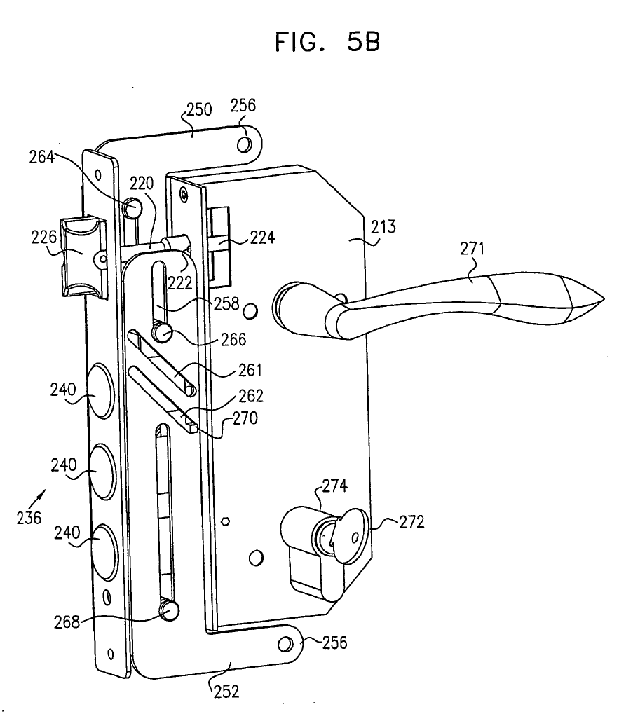

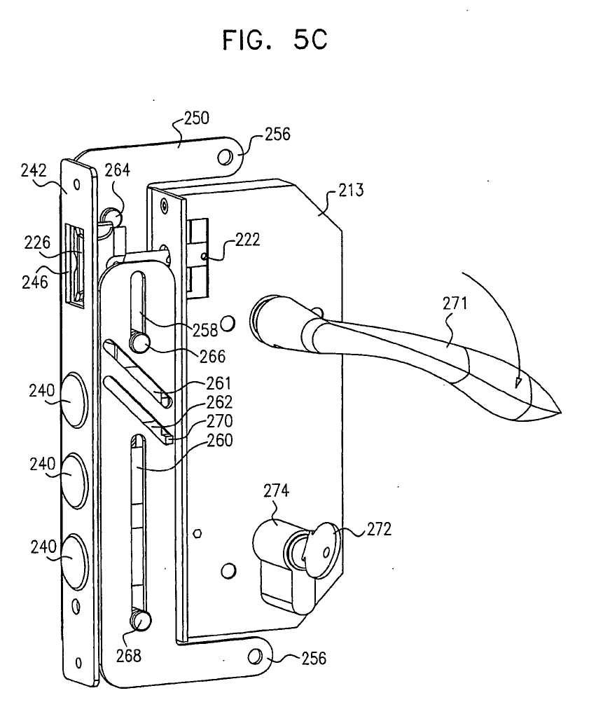

Reference is now made to FIGS. 4A, 4B and 4C, which are simplified exploded view pictorial illustrations of an enhanced action multiple direction lock assembly constructed and operative in accordance with a preferred embodiment of the present invention in three alternative operative orientations and to FIGS. 5A, 5B and 5C which are corresponding assembled views. As seen in FIGS. 4A-4C and 5A-5C, an enhanced action assembly 210 is mounted, as by screw fasteners or rivets 212, onto an outer edge of a conventional lock, here a mortise lock 213.

The enhanced action assembly 210 preferably comprises an assembly support 214 including a mounting panel 216 which is mounted by screw fasteners or rivets 212 onto the outer edge of the mortise lock 213 and which is preferably integrally formed with a side panel 218, which extends outwardly from mounting panel 216 and is preferably integrally formed therewith.

A latch elongating assembly 220 is preferably mounted, as by a set screw 222, onto a latch shaft 224 of the mortise lock 213. A latch 226 is mounted to an outer facing end of assembly 220.

A bolt elongating shaft assembly 230 is preferably mounted, as by set screws 232, onto a bolt 234 of the mortise lock 213. A multiple bolt assembly 236 is mounted to an outer facing end of assembly 230. Multiple bolt assembly 236 preferably comprises a base 238 onto which are mounted a plurality of bolts 240. An edge plate 242 is provided for mounting on an edge of a door (not shown) and is suitably apertured with mounting screw mounting apertures 244, a latch aperture 246 and bolt apertures 248.

First and second bolt extension actuating plates 250 and 252, which are preferably identical are arranged in mutually upside down and mirror image orientations on respective opposite sides of assembly support 214. Each of plates 250 and 252 comprises a generally L-shaped planar plate, having an upstanding portion 254, in the sense of FIGS. 4A-5C and a relatively narrow leg portion 256. Each upstanding portion is preferably formed with a pair of co-axial spaced elongate slots 258 and 260 and a pair of diagonal slots 261 and 262.

Elongate slots 258 and 260 of plate 250 are engaged by respective pins 264 and 266, while elongate slots 258 and 260 of plate 252 are engaged by respective pins 266 and 268. Pins 264, 266 and 268 are fixed to and extend outwardly from side panel 218.

Plates 250 and 252 are driven in up and down motion in the sense of FIGS. 4A-5C by sliding engagement of protrusions 270, extending outwardly in opposite directions from base 238, with diagonal slots 260 and 262 in the respective plates. It is appreciated that typically, when the bolt assembly 230 is extended laterally, as in FIGS. 4A and 5A, the plates 250 and 252 are also extended in directions perpendicular to the extension of the bolt assembly 230. Likewise, when the bolt assembly 230 is retracted, the plates 250 and 252 are retracted, as seen in FIGS. 4B and 5B. The operation of the latch is similar to that described hereinabove with reference to FIGS. 1A-1C.

It is seen from a consideration of FIGS. 4A and 5A, that the latch 226, the bolts 240 and the plates 250 and 252 are fully extended when a lock handle 271 is in a generally horizontal position and when a key 272 in a cylinder 274 is in a first rotational orientation, here shown tilted to the left.

It is seen from a consideration of FIGS. 4B and 5B, that when key 272 in cylinder 274 is in a second rotational orientation, here shown tilted to the right, bolts 240 and plates 250 and 252 are fully retracted.

It is seen from a consideration of FIGS. 4C and 5C, that the latch 226, the bolts 240 and the plates 250 and 252 are fully retracted when lock handle 271 is in a generally downwardly tilted position and when key 272 in cylinder 274 is in a second rotational orientation, here shown tilted to the right.

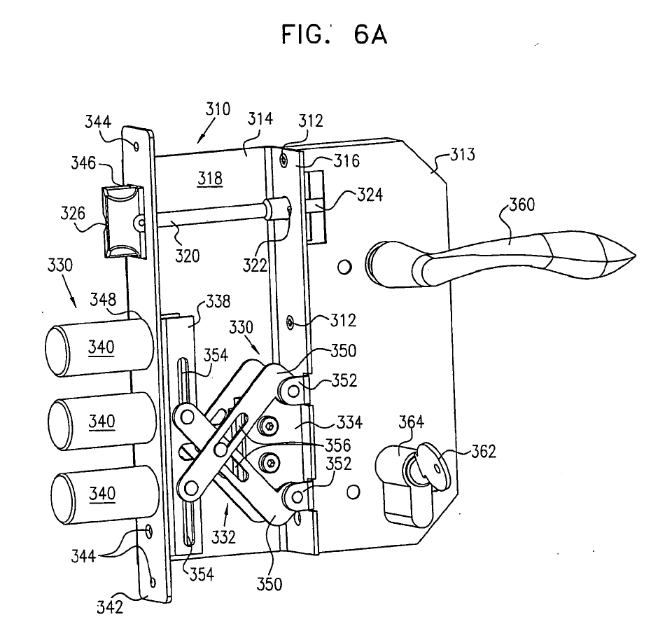

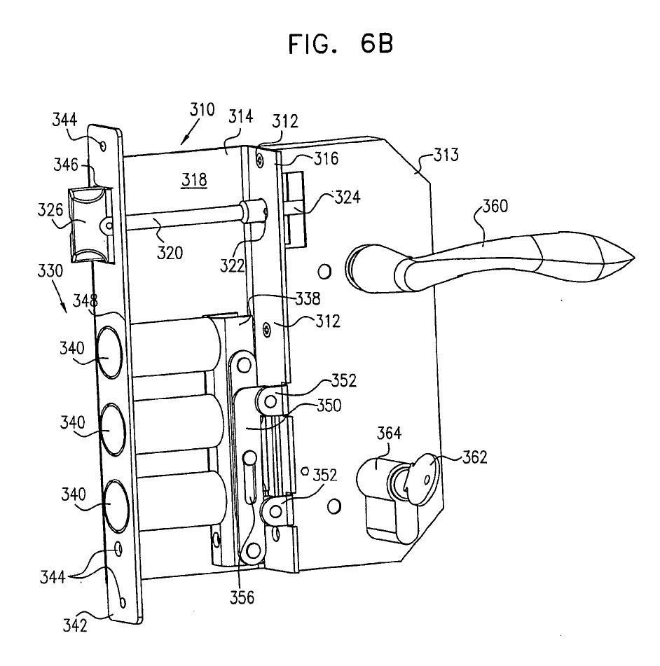

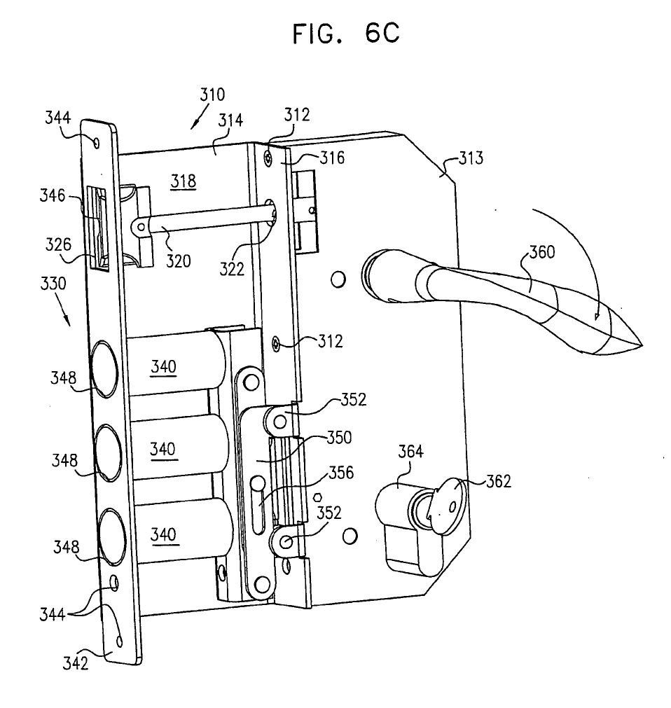

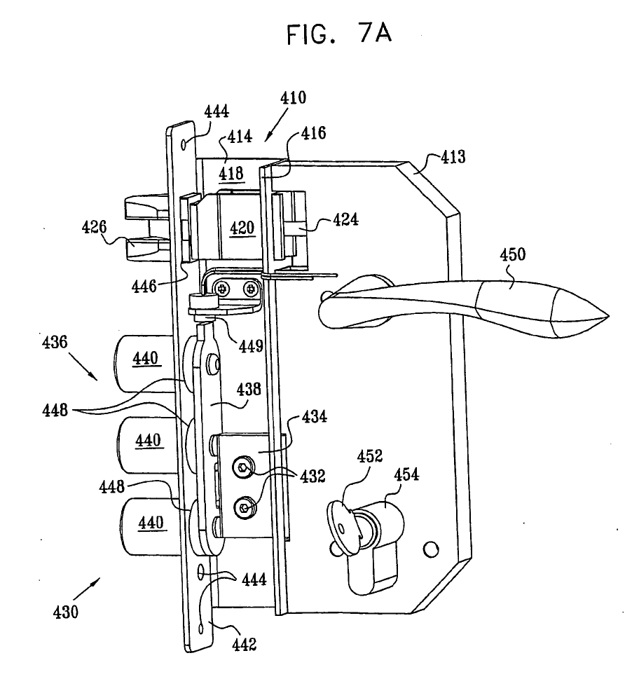

Reference is now made to FIGS. 6A, 6B and 6C, which are simplified pictorial illustrations of an enhanced action extended throw lock assembly constructed and operative in accordance with a preferred embodiment of the present invention in three alternative operative orientations. As seen in FIGS. 6A, 6B and 6C, an enhanced action assembly 310 is mounted, as by screw fasteners or rivets 312, onto an outer edge of a conventional lock, here a mortise lock 313.

The enhanced action assembly-310 preferably comprises an assembly support 314 including a mounting panel 316 which is mounted by screw fasteners or rivets 312 onto the outer edge of the mortise lock 313 and which is preferably integrally formed with a side panel 318, which extends outwardly from mounting panel 316 and is preferably integrally formed therewith A latch elongating assembly 320 is preferably mounted, as by a set screw 322, onto a latch shaft 324 of the mortise lock 313. A latch 326 is mounted to an outer facing end of assembly 320.

A multiple bolt assembly 330 is preferably mounted via a scissors mechanism 332 onto a bolt 334 of lock 313. Multiple bolt assembly 330 preferably comprises a base 338 onto which are mounted a plurality of bolts 340. An edge plate 342 is provided for mounting on an edge of a door (not shown) and is suitably apertured with mounting screw mounting apertures 344, a latch aperture 346 and bolt apertures 348.

Scissors mechanism 332 preferably comprises two sets of mutually intersecting arms 350 which are pivotably mounted onto lugs 352 extending outwardly from mounting panel 316 and engage elongate slots 354 formed in base 338. Each of arms 350 is formed with an elongate slot 356. A pin 358, mounted on bolt 334, engages elongate slots 356 of arms 350. It is appreciated that the scissors mechanism 332 amplifies the throw of bolt 334 of lock 313.

It is seen from a consideration of FIG. 6A, that both the latch 326 and the bolts 340 are fully extended when a lock handle 360 is in a generally horizontal position and when a key 362 in a cylinder 364 is in a first rotational orientation, here shown tilted to the left.

It is seen from a consideration of FIG. 6B, that when key 362 in cylinder 364 is in a second rotational orientation, here shown tilted to the right, bolts 340 are fully retracted.

It is seen from a consideration of FIG. 6C, that both the latch 326 and the bolts 340 are fully retracted when lock handle 360 is in a generally downwardly tilted position and when key 362 in cylinder 364 is in a second rotational orientation, here shown tilted to the right.

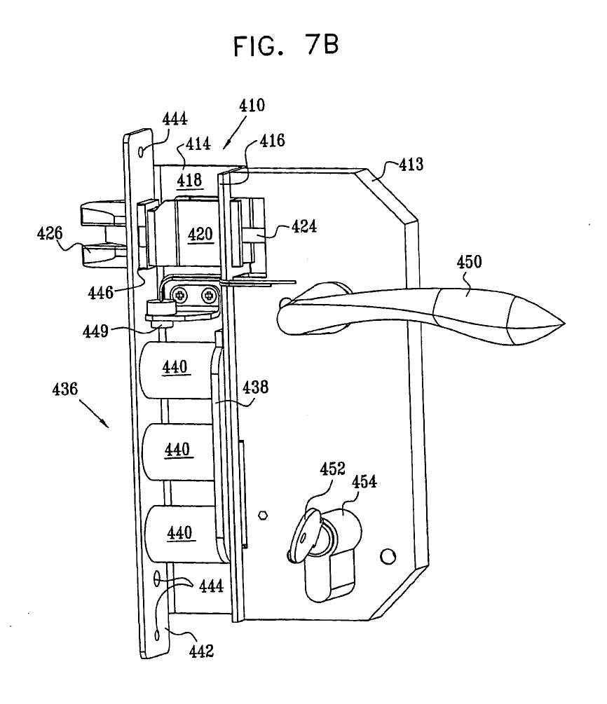

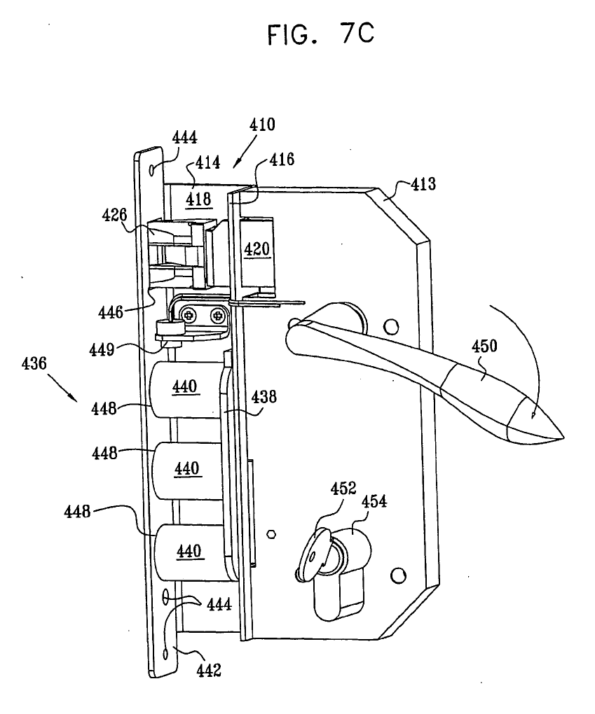

Reference is now made to FIGS. 7A, 7B and 7C, which are simplified pictorial illustrations of an enhanced action electrically monitored lock assembly constructed and operative in accordance with a preferred embodiment of the present invention in three alternative operative orientations. As seen in FIGS. 7A, 7B and 7C, an enhanced action assembly 410 is mounted, as by screw fasteners or rivets, onto an outer edge of a conventional lock, here a mortise lock 413.

The enhanced action assembly 410 preferably comprises an assembly support 414 including a mounting panel 416 which is mounted by screw fasteners or rivets onto the outer edge of the mortise lock 413 and which is preferably integrally formed with a side panel 418, which extends outwardly from mounting panel 416 and is preferably integrally formed therewith.

A latch elongating assembly 420 is preferably mounted onto a latch shaft 424 of the mortise lock 413. A latch 426, here a multi-element latch, is mounted to an outer facing end of assembly 420.

A bolt elongating shaft assembly 430 is preferably mounted, as by set screws 432, onto a bolt 434 of the mortise lock 413. A multiple bolt assembly 436 is mounted to an outer facing end of assembly 430. Multiple bolt assembly 436 preferably comprises a base 438 onto which are mounted a plurality of bolts 440. An edge plate 442 is provided for mounting on an edge of a door (not shown) and is suitably apertured with mounting screw mounting apertures 444, a latch aperture 446 and bolt apertures 448. The position of the multiple bolt assembly 436 is here electrically monitored by a sensor 449, such as a magnetic sensor or any other suitable sensor.

It is seen from a consideration of FIG. 7A, that both the latch 426 and the bolts 440 are fully extended when a lock handle 450 is in a generally horizontal position and when a key 452 in a cylinder 454 is in a first rotational orientation, here shown tilted to the left.

It is seen from a consideration of FIG. 7B, that when key 452 in cylinder 454 is in a second rotational orientation, here shown tilted to the right, bolts 440 are fully retracted.

It is seen from a consideration of FIG. 7C, that both the latch 426 and the bolts 440 are fully retracted when lock handle 450 is in a generally downwardly tilted position and when key 452 in cylinder 454 is in a second rotational orientation, here shown tilted to the right.

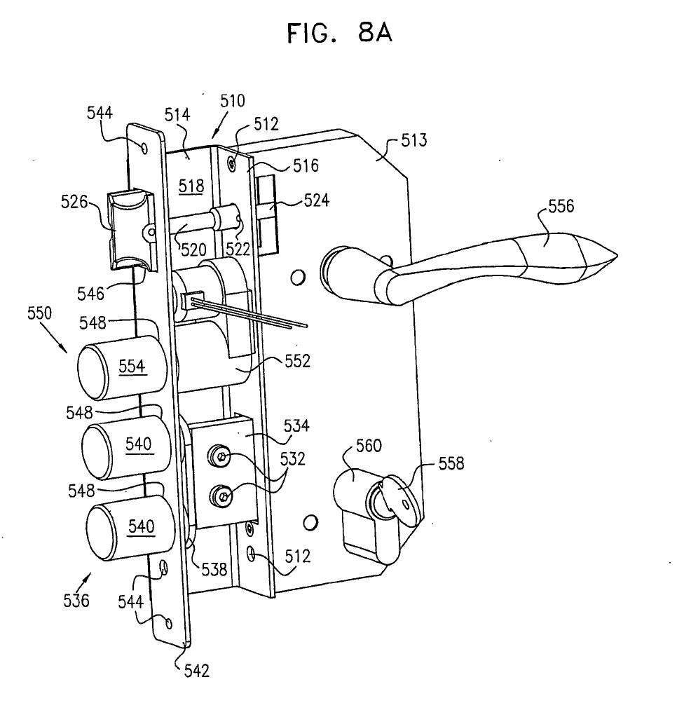

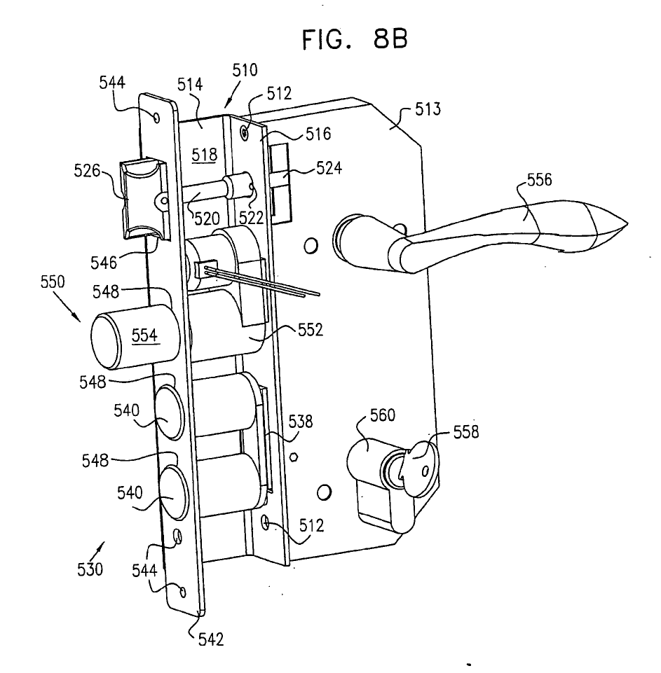

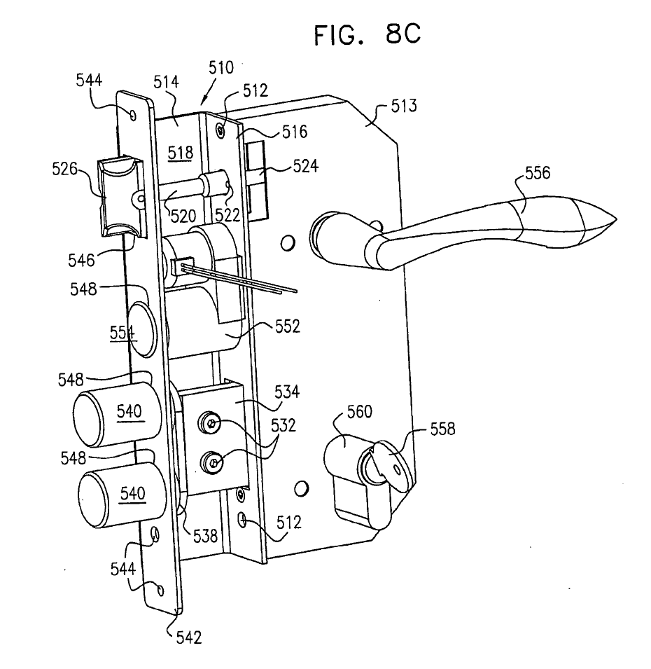

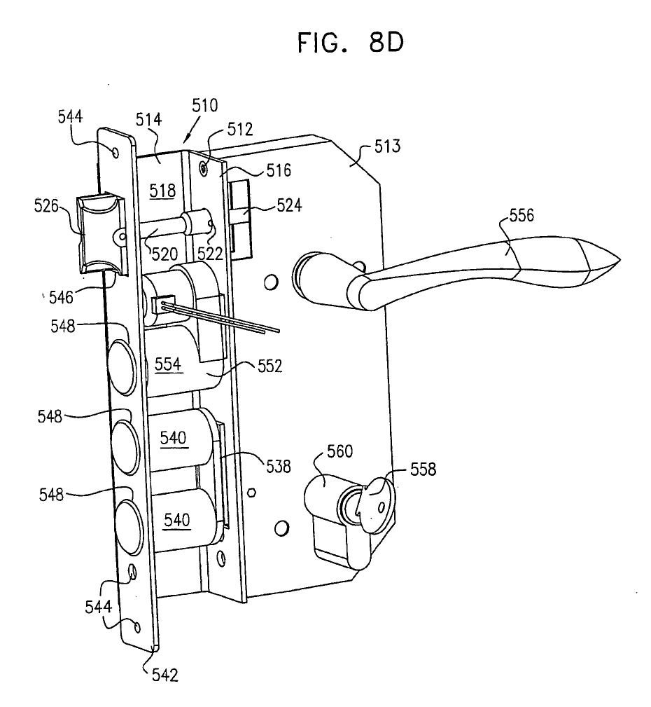

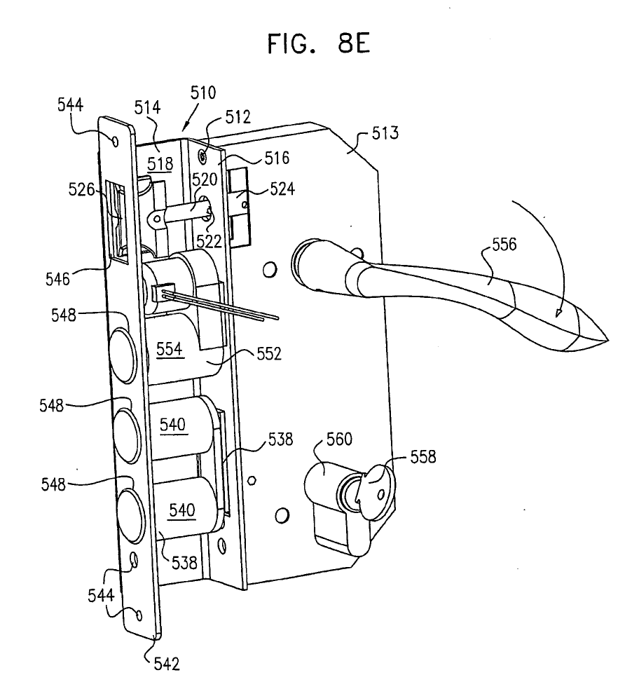

Reference is now made to FIGS. 8A, 8B, 8C, 8D and 8E, which are simplified pictorial illustrations of one type of an enhanced action partially electrically operated and partially mechanically operated lock assembly constructed and operative in accordance with a preferred embodiment of the present invention in five alternative operative orientations. As seen in FIGS. 8A, 8B, 8C, 8D and 8E an enhanced action assembly 510 is mounted, as by screw fasteners or rivets 512, onto an outer edge of a conventional lock, here a mortise lock 513.

The enhanced action assembly 510 preferably comprises an assembly support 514 including a mounting panel 516 which is mounted by screw fasteners or rivets 512 onto the outer edge of the mortise lock 513 and which is preferably integrally formed with a side panel 518, which extends outwardly from mounting panel 516 and is preferably integrally formed therewith.

A latch elongating assembly 520 is preferably mounted, as by a set screw 522, onto a latch shaft 524 of the mortise lock 513. A latch 526, here a multi-element latch, is mounted to an outer facing end of assembly 520.

A bolt elongating shaft assembly 530 is preferably mounted, as by set screws 532, onto a bolt 534 of the mortise lock 513. A multiple bolt assembly 536 is mounted to an outer facing end of assembly 530. Multiple bolt assembly 536 preferably comprises a base 538 onto which are mounted a plurality of bolts 540. An edge plate 542 is provided for mounting on an edge of a door (not shown) and is suitably apertured with mounting screw mounting apertures 544, a latch aperture 546 and bolt apertures 548.

An electrically operated bolt assembly 550 is additionally provided and includes an electrical driver 552, such as a solenoid, and an extendible bolt 554.

It is seen from a consideration of FIG. 8A, that the latch 526, bolts 540 and electrically driven bolt 554 are fully extended when a lock handle 556 is in a generally horizontal position, a key 558 in a cylinder 560 is in a first rotational orientation, here shown tilted to the left, and driver 552 is suitably electrically actuated.

It is seen from a consideration of FIG. 8B, that when key 558 in cylinder 560 is in a second rotational orientation, here show tilted to the right, the lock handle 556 remains in its generally horizontal position and driver 552 remains suitably electrically actuated, bolts 540 are fully retracted and bolt 554 remains extended.

It is seen from a consideration of FIG. 8C, that when key 558 in cylinder 560 is in its first rotational orientation, here shown tilted to the left, the lock handle 556 remains in its generally horizontal position and driver 552 is deactuated, bolts 540 are fully extended and bolt 554 is retracted.

It is seen from a consideration of FIG. 8D, that when key 558 in cylinder 560 is in a second rotational orientation, here shown tilted to the right, the lock handle 556 remains in its generally horizontal position and driver 552 is deactuated, bolts 540 and bolt 554 are fully retracted.

It is seen from a consideration of FIG. 8E, that when key 558 in cylinder 560 is in a second rotational orientation, here shown tilted to the right, the lock handle 556 is in a generally downwardly tilted position and driver 552 is deactuated, bolts 540 and bolt 554 are fully retracted and latch 526 is fully retracted.

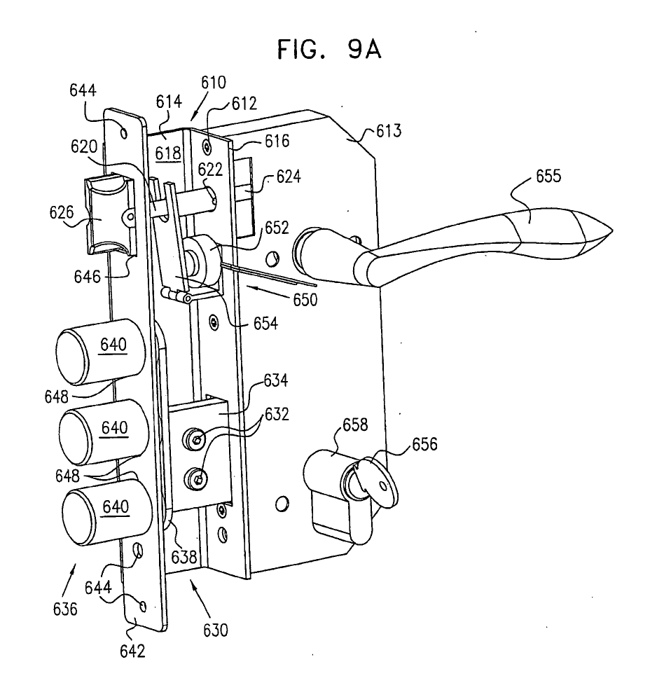

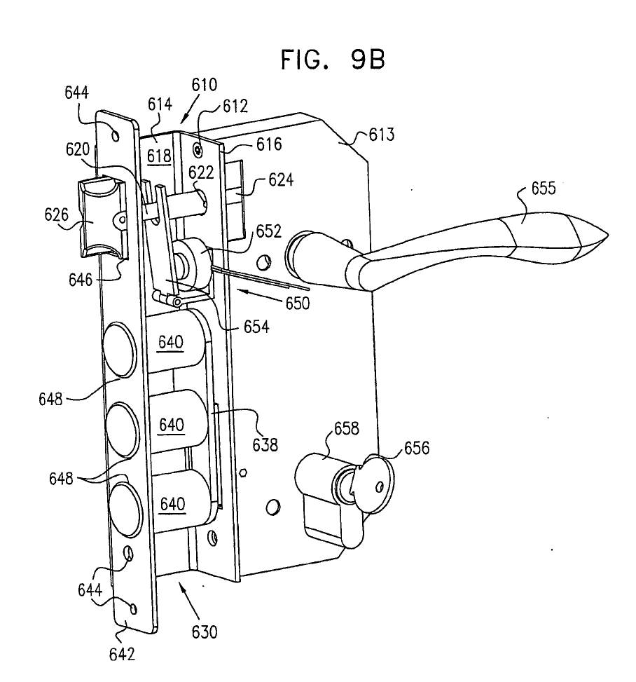

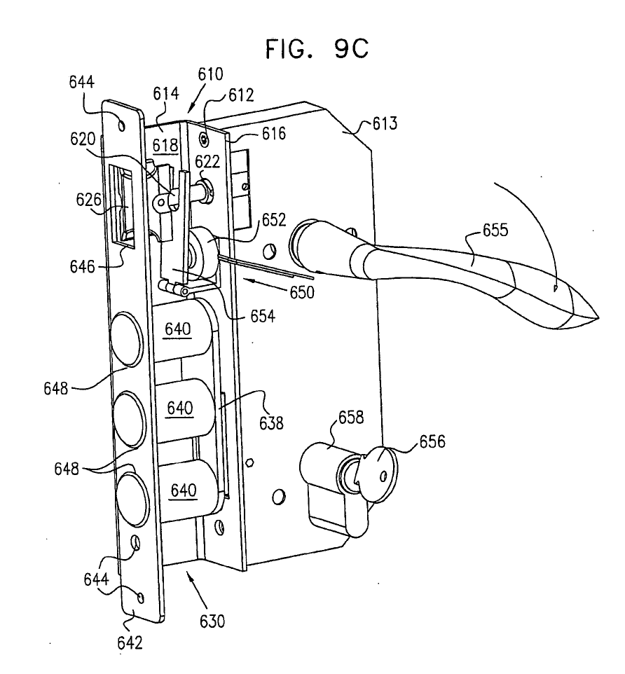

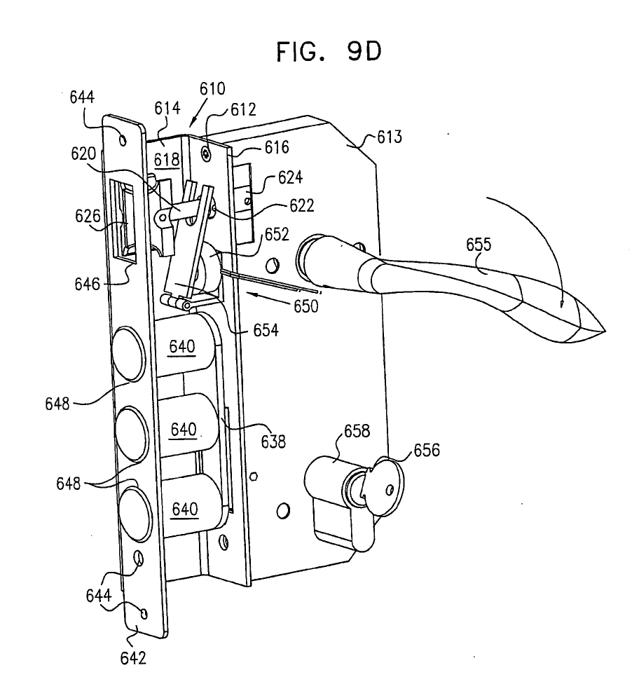

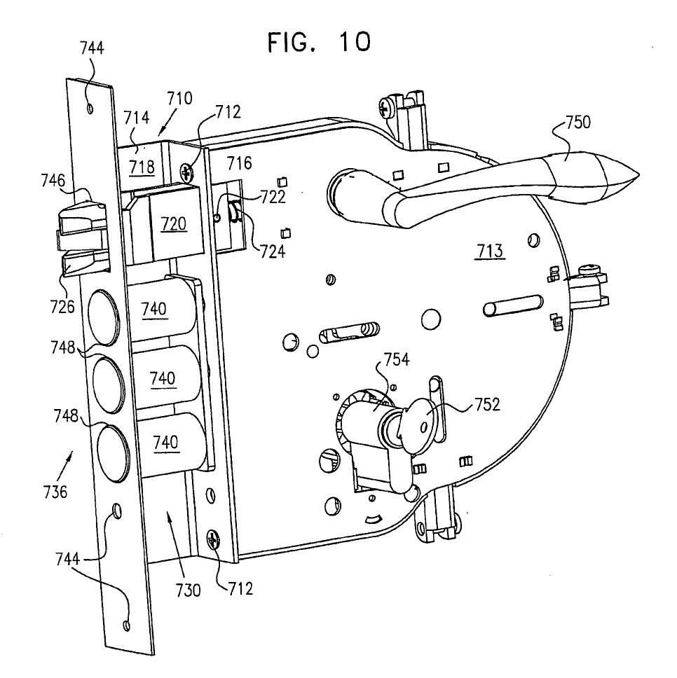

Reference is now made to FIGS. 9A, 9B, 9C and 9D, which are simplified pictorial illustrations of another type of an enhanced action partially electrically operated and partially mechanically operated Lock assembly constructed and operative in accordance with a preferred embodiment of the present invention in four alternative operative orientations.

As seen in FIGS. 9A, 9B, 9C and 9D, an enhanced action assembly 610 is mounted, as by screw fasteners or rivets 612, onto an outer edge of a conventional lock, here a mortise lock 613.

The enhanced action assembly 610 preferably comprises an assembly support 614 including a mounting panel 616 which is mounted by screw fasteners or rivets 612 onto the outer edge of the mortise lock 613 and which is preferably integrally formed with a side panel 618, which extends outwardly from mounting panel 616 and is preferably integrally formed therewith.

A latch elongating assembly 620 is preferably mounted, as by a set screw 622, onto a latch shaft 624 of the mortise lock 613. A latch 626, here a multi-element latch, is mounted to an outer facing end of assembly 620.

A bolt elongating shaft assembly 630 is preferably mounted, as by set screws 632, onto a bolt 634 of the mortise lock 613. A multiple bolt assembly 636 is mounted to an outer facing end of assembly 630. Multiple bolt assembly 636 preferably comprises a base 638 onto which are mounted a plurality of bolts 640. An edge plate 642 is provided for mounting on an edge of a door (not shown) and is suitably apertured with mounting screw mounting apertures 644, a latch aperture 646 and bolt apertures 648.

An electrically operated auxiliary latch retraction assembly 650, typically comprising a driver 652, such as a solenoid which positions a hinged lever 654, provides electrically controllable latch retraction.

It is seen from a consideration of FIG. 9A, that both the latch 626 and the bolts 640 are fully extended when a lock handle 655 is in a generally horizontal position, a key 656 in a cylinder 658 is in a first rotational orientation, here shown tilted to the left, and driver 652 is not actuated.

It is seen from a consideration of FIG. 9B, that when key 656 in cylinder 658 is in a second rotational orientation, here shown tilted to the right, bolts 640 are fully retracted.

It is seen from a consideration of FIG. 9C, that both the latch 626 and the bolts 640 are fully retracted when lock handle 655 is in a generally downwardly tilted position and when key 656 in cylinder 658 is in a second rotational orientation, here shown tilted to the right.

It is seen from a consideration of FIG. 9D, that both the latch 626 and the bolts 640 are fully retracted even when lock handle 655 is in a generally downwardly tilted position and when key 656 in cylinder 658 is in a second rotational orientation, here shown tilted to the right, provided that driver 652 is actuated, causing lever 654 to retract latch 626.

Reference is now made to FIG. 10, which is a simplified pictorial illustration of another type of enhanced action multiple direction lock assembly constructed and operative in accordance with a preferred embodiment of the present invention. In the embodiment of FIG. 10, an enhanced action assembly 710 is mounted, as by screw fasteners or rivets 712, onto an outer edge of a known multiple bolt mortise lock 713, here, Model 265 commercially available from Mul-T-Lock Ltd. of Yavne, Israel.

The enhanced action assembly 710 preferably comprises an assembly support 714 including a mounting panel 716 which is mounted by screw fasteners or rivets 712 onto the outer edge of the mortise lock 713 and which is preferably integrally formed with a side panel 718, which extends outwardly from mounting panel 716 and is preferably integrally formed therewith.

A latch elongating assembly 720 is preferably mounted, as by a set screw 722, onto a latch shaft 724 of the mortise lock 713. A latch 726, here a multi-element latch, is mounted to an outer facing end of assembly 720.

A bolt elongating shaft assembly 730 is preferably mounted onto a bolt of the mortise lock 713. A multiple bolt assembly 736 is mounted to an outer facing end of assembly 730. Multiple bolt assembly 736 preferably comprises a base 738 onto which are mounted a plurality of bolts 740. An edge plate 742 is provided for mounting on an edge of a door (not shown) and is suitably apertured with mounting screw mounting apertures 744, a latch aperture 746 and bolt apertures 748.

It is seen from a consideration of FIG. 10, that the latch 726 is fully extended and the bolts 740 are fully retracted when a lock handle 750 is in a generally horizontal position and when a key 752 in a cylinder 754 is tilted to the right as shown.

It will be appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specification and which are not in the prior art.

1. A modular, enhanced action, lock assembly comprising:
a lock assembly providing axial bolt driving along at least one longitudinal axis; and
an enhanced action assembly, mounted onto the lock assembly for being driven at least partially by said axial bolt driving along said at least one longitudinal axis for providing enhanced locking action.

2. A modular, enhanced action, lock assembly according to claim 1 and wherein said lock assembly comprises a manually driven lock assembly.

3. A modular, enhanced action, lock assembly according to claim 1 and wherein said lock assembly comprises an at least partially electrically driven lock assembly.

4. A modular, enhanced action, lock assembly according claim 1 and wherein said enhanced action assembly provides, in response to said axial bolt driving, a multiple bolt locking action.

5. A modular, enhanced action, lock assembly according to claim 1 and wherein said enhanced action assembly provides, in response to said axial bolt driving, a drop bolt locking action.

6. A modular, enhanced action, lock assembly according to claim 1 and wherein said enhanced action assembly provides, in response to said axial bolt driving, a multiple direction locking action.

7. A modular, enhanced action, lock assembly according to claim 1 and wherein said enhanced action assembly provides, in response to said axial bolt driving, an extended throw locking action.

8. A modular, enhanced action, lock assembly according to claim 1 and wherein said enhanced action assembly provides, in response to said axial bolt driving, an electrically monitored locking action.

9. A modular, enhanced action, lock assembly according to claim 1 and wherein said enhanced action assembly provides, partially in response to said axial bolt driving, a partially electrically operated and partially mechanically operated locking action.

10. A modular, enhanced action, lock assembly according claim 1 and wherein said enhanced action assembly provides, partially in response to said axial bolt driving, a partially electrically operated and partially mechanically operated locking action wherein at least one of a latch and at least one of a bolt are differently operated.

11. An enhanced action assembly for use in a modular, enhanced action, lock assembly comprising a lock assembly providing axial bolt driving along at least one longitudinal axis, said enhanced action assembly, mounted onto said lock assembly for being driven at least partially by said axial bolt driving along said at least one longitudinal axis for providing enhanced locking action.

12. An enhanced action assembly according to claim 11 and wherein said lock assembly comprises a manually driven lock assembly.

13. An enhanced action assembly according to claim 11 and wherein said lock assembly comprises an at least partially electrically driven lock assembly.

14. An enhanced action assembly according to claim 11 and wherein said enhanced action assembly provides, in response to said axial bolt driving, a multiple bolt locking action.

15. An enhanced action assembly according to claim 11 and wherein said enhanced action assembly provides, in response to said axial bolt driving, a drop bolt locking action.

16. An enhanced action assembly according to claim 11 and wherein said enhanced action assembly provides, in response to said axial bolt driving, a multiple direction locking action.

17. An enhanced action assembly according to claim 11 and wherein said enhanced action assembly provides, in response to said axial bolt driving, an extended throw locking action.

18. An enhanced action assembly according to claim 11 and wherein said enhanced action assembly provides, in response to said axial bolt driving, an electrically monitored locking action.

19. An enhanced action assembly according to claim 11 and wherein said enhanced action assembly provides, partially in response to said axial bolt driving, a partially electrically operated and partially mechanically operated locking action.

20. An enhanced action assembly according to claim 11 and wherein said enhanced action assembly provides, partially in response to said axial bolt driving, a partially electrically operated and partially mechanically operated locking action wherein at least one of a latch and at least one of a bolt are differently operated.
